(19) United States
(12) Patent Application Publication
(10) Pub. No.: US 2004/0047323 A1
(43) Pub. Date: Mar. 11, 2004

(54) Method for selecting system and transmitting data for WLAN and mobile phone network interworking service

(75) Inventors: Seong-Soo Park, Seoul (KR); Dong-Hahk Lee, Seongnam-si (KR)

Correspondence Address: LAHIVE & COCKFIELD, LLP., 28 STATE STREET, BOSTON, MA, 02109, US

(73) Assignee: SK Telecom Co., Ltd., Seoul (KR)

(21) Appl. No.: 10/425,524

(22) Filed: Apr. 28, 2003

(30) Foreign Application Priority Data
Aug. 30, 2002 (KR) 10-2002-0051716

(51) Int. Cl. H04Q 7/24

(52) U.S. Cl. 370/338; 370/401

(57) ABSTRACT

The present invention discloses a method for selecting a system and transmitting data for a WLAN/mobile phone network interworking service in a WLAN and mobile phone network interworking system, which includes: a signal measuring step for setting up a service set ID list of a WLAN in an access point in order for a terminal to allow access, and measuring signal strength for the WLAN access; an access deciding step for selecting an access system based on the signal strength measured in the signal measuring step; a WLAN performing step for periodically measuring signal strength of a WLAN channel satisfying the access allowable service set ID list, and accessing the corresponding WLAN channel or a mobile phone network according to the existence or absence of the WLAN channel guaranteeing signal quality for the WLAN access, when the WLAN access is confirmed in the access deciding step; and a mobile phone network performing step for periodically measuring signal strength of the WLAN channel satisfying the access allowable service set ID list, and converting the mobile phone network access into the WLAN access according to sufficient signal strength for the access, when the mobile phone network access is confirmed in the access deciding step, thereby efficiently interworking services between the WLAN and the mobile phone network. As a result, the wireless internet service can be facilitated.

### BACKGROUND OF THE INVENTION

1. Field of the Invention

The present invention relates to a method for selecting a system and transmitting data for a WLAN/mobile phone network interworking service, and in particular to a method for selecting a data transmission system and transmitting data through the system which can provide an interworking service in an environment where a WLAN which provides a high speed wireless internet access service based on hot spots and a mobile phone network which provides a national communication service coexist.

2. Description of the Background Art

Recently, demands of users for internet access have considerably increased and expanded into wireless sections due to huge distributions of a very high speed internet service. Accordingly, communication providers in the country or abroad attempt to provide the very high speed internet service by using a WLAN.

However, a service area of one access point of the WLAN exists within a 100 m-radius, which is very different from a few hundreds m to a few Km of a mobile phone network. Therefore, the WLAN cannot provide mobility and service coverage as in the mobile phone network.

It is thus necessary to provide an interworking service which uses the WLAN in the area where a lot of users demand the very high speed wireless internet service, and the mobile phone network in the other areas.

For this, the WLAN and mobile phone network services need to be interworked in different systems and frequencies.

However, a method for selecting a communication system among different kinds of systems and a roaming method for providing a data service are required to provide the interworking service, which have not yet been suggested. As a result, the users receive a simple portability service between the WLAN and the mobile phone network, but not the roaming service guaranteeing continuity of service.

### SUMMARY OF THE INVENTION

Accordingly, it is an object of the present invention to provide a method for selecting a data transmission system and transmitting data through the system which can provide an interworking service in an environment where a WLAN which provides a high speed wireless internet access service based on hot spots and a mobile phone network which provides a national communication service coexist.

In order to achieve the above-described object of the invention, there is provided a method for selecting a system and transmitting data for a WLAN/mobile phone network interworking service in a WLAN/mobile phone network interworking system, including: a signal measuring step for setting up a service set ID list of a WLAN in an access point in order for a terminal to allow access, and measuring signal strength for the WLAN access; an access deciding step for selecting an access system based on the signal strength measured in the signal measuring step; a WLAN performing step for periodically measuring signal strength of a WLAN channel satisfying the access allowable service set ID list, and accessing the corresponding WLAN channel or a mobile phone network according to the existence or absence of the WLAN channel guaranteeing signal quality for the WLAN access, when the WLAN access is confirmed in the access deciding step; and a mobile phone network performing step for periodically measuring signal strength of the WLAN channel satisfying the access allowable service set ID list, and converting the mobile phone network access into the WLAN access according to sufficient signal strength for the access, when the mobile phone network access is confirmed in the access deciding step.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a WLAN/mobile phone network interworking system which the present invention can be applied to;

FIG. 2 is a structure view illustrating cells of a mobile phone network and a WLAN used for the present invention;

FIG. 3 is a flowchart showing a procedure of selecting a system in a mobile terminal in accordance with the present invention;

FIG. 4 is an exemplary view illustrating a procedure of interworking data services during a roaming operation from the WLAN to the mobile phone network in accordance with the present invention; and

FIG. 5 is an exemplary view illustrating a procedure of interworking data services during a roaming operation from the mobile phone network to the WLAN in accordance with the present invention.

### DETAILED DESCRIPTION OF THE PREFERRED EMBODIMENTS

A method for selecting a system and transmitting data for a WLAN/mobile phone network interworking service in accordance with a preferred embodiment of the present invention will now be described in detail with reference to the accompanying drawings.

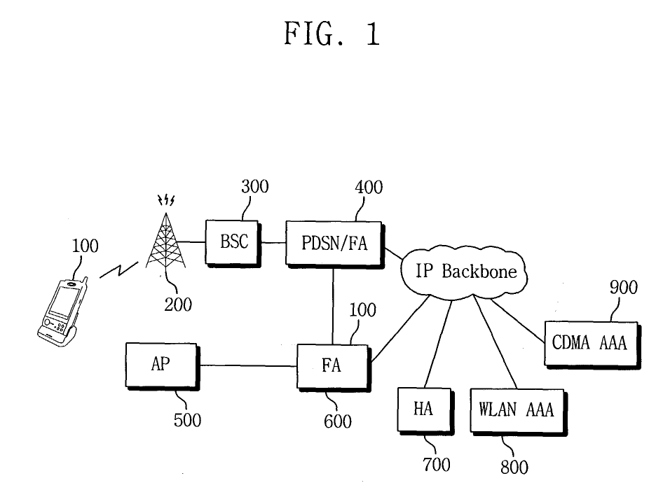

FIG. 1 is a structure view illustrating a WLAN/mobile phone network interworking system which the present invention can be applied to.

Referring to FIG. 1, a WLAN includes a mobile terminal 100 which a network interface card (NIC) is mounted on, an access point (AP) 500 and an authentication server (AAA) 800, and a foreign agent (FA) 600 for mobile IP support is positioned between the AAA 800 and the AP 500.

A mobile phone network includes a mobile terminal 100, a base station (BTS) 200, a base station controller (BSC) 300, a packet data service node (PSDN) 400 for processing data, and an authentication server (AAA) 900.

The operation of the present invention will now be described with reference to the accompanying drawings.

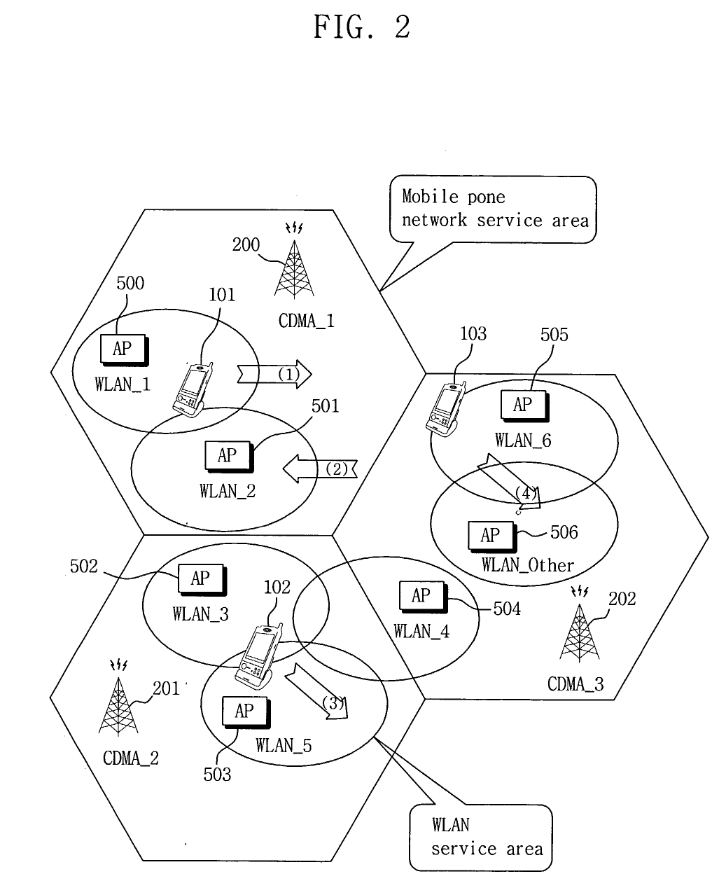

FIG. 2 is a structure view illustrating cells of the mobile phone network and the WLAN used for the present invention.

As illustrated in FIG. 2, a service coverage of the BTS of the mobile phone network is larger than that of the AP of the WLAN. Therefore, service interworking between the WLAN and the mobile phone network (arrows 1 and 2), service interworking between the WLAN and the WLAN (arrow 3), and service interworking when an AP for WLAN of another provider exists (arrow 4) must be all considered to interwork the WLAN and mobile phone network services.

In the case of service interworking between the WLAN and the mobile phone network, the access system must be decided between the mobile phone network and the WLAN. That is, WLAN signal strength is periodically measured, and then the access system is selected according to the measured signal strength. As indicated by arrow 1, a mobile terminal 101 transmits/receives data to/from the WLAN and measures WLAN signal strength. When the measured signal strength is smaller than a reference value, the mobile terminal 101 transmits/receives data to/from the mobile phone network.

In the case of service interworking between the WLAN and the mobile phone network (arrow 2); the mobile terminal 101 transmits/receives data to/from the mobile phone network and periodically measures WLAN signal strength. When the measured signal strength is greater than a reference value, the mobile terminal 101 transmits/receives data to/from the WLAN.

In addition, in the case of service interworking between the WLAN and the WLAN (arrow 3), a WLAN cell (WLAN_{—}5) 503 is adjacent to a WLAN cell (WLAN_{—}3) 502 which a mobile terminal 102 is located in. When signal strength of the current WLAN cell is smaller than a reference value, the mobile terminal 102 detects signal strength of the adjacent WLAN cell having an access allowable service set ID (SSID), and selects an optimal WLAN cell for data transmission and reception.

On the other hand, service interworking when the AP for WLAN of another provider exists (arrow 4) is different from the service interworking between the WLAN and the WLAN (arrow 3) merely in that the adjacent WLAN cell is a WLAN cell of an individual user or another provider. Here, if WLAN signal strength of a current WLAN cell (WLAN 6) 505 decreases, a mobile terminal 103 transmits/receives data to/from the mobile phone network.

In order to satisfy the aforementioned conditions, the SSIDs used as system identifiers in the WLAN must be set up in the AP to be distinguished from other providers or individual users. That is, when signal strength from the AP of the current WLAN cell decreases, the mobile terminal detects signals of the AP of the adjacent WLAN cell. Here, the mobile terminal measures signal strength only of the AP having the access allowable SSID. If the mobile terminal does not receive the WLAN signal having the access allowable SSID, it attempts to access the mobile phone network.

The process of deciding a communication mode based on WLAN signal strength will now be explained in more detail.

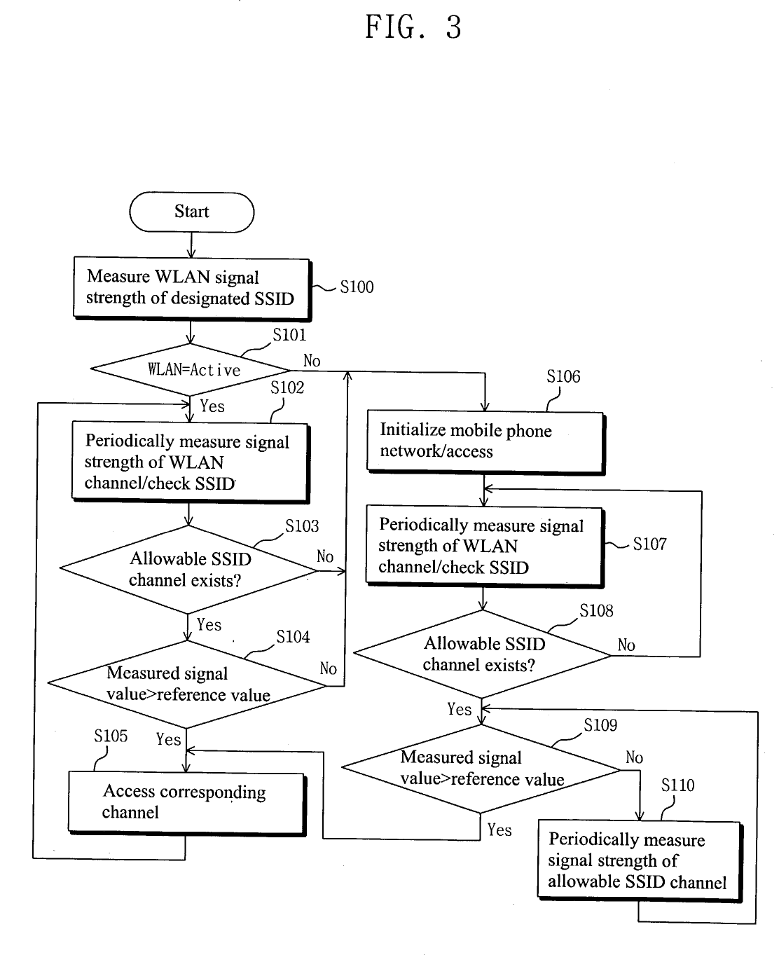

FIG. 3 is a flowchart showing a procedure of selecting the system in the mobile terminal in accordance with the present invention. As depicted in FIG. 3, the mobile terminal must store the SSID list of the WLAN to allow access. The mobile terminal measures signal strength for the WLAN access in an initial stage, periodically measures signal strength of a WLAN channel satisfying the access allowable SSID list (S100), and selects an access system according to the signal strength measured in S100.

In order to decide the access system, the mobile terminal confirms whether the WLAN is in an active state (S101). If the WLAN is in the active state, the mobile terminal goes to S102, and if not, the mobile terminal goes to S106.

When the WLAN is in the active state in S101, the mobile terminal periodically measures signal strength of the current channel in the WLAN communication state. When the measured value is smaller than a reference value, the mobile terminal measures signal strength of other WLAN channels and confirms the SSID (S102).

The mobile terminal confirms whether channels having the access allowable SSID exist among the channels having values over the reference value in S102 (S103). If such channels exist in S103, the mobile terminal confirms whether the measured signal value is greater than a previously-set reference value in order to extract the channel having the largest signal strength among the channels (S104). When the measured signal value is over the reference value in S104, the mobile terminal accesses the AP of the corresponding channel (S105).

When the WLAN is not in the active state in S101, the mobile terminal initializes and accesses the mobile phone network (S106), periodically measures signal strength of the WLAN channel and confirms the SSID (S107). The mobile terminal confirms whether channels having the access allowable SSID exist (S108). If such channels exist, the mobile terminal confirms whether the measured signal value is greater than a reference value (S109).

When the measured signal value is greater than the reference value in S109, the mobile terminal accesses the corresponding WLAN channel (S105), and when it is smaller than the reference value, the mobile terminal periodically measures signal strength of the other WLAN channels having the access allowable SSID (S110), and repeats S109 based on the measured result.

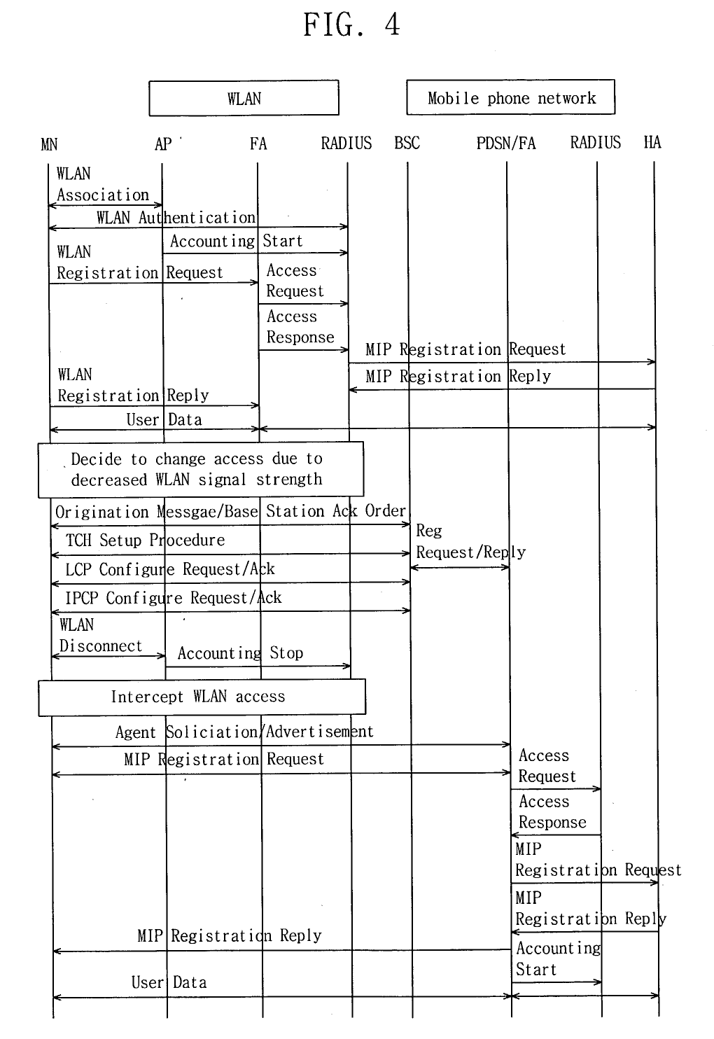

FIG. 4 is an exemplary view illustrating a procedure of interworking data services during a roaming operation from the WLAN to the mobile phone network in accordance with the present invention.

Referring to FIG. 4, when the mobile terminal 100 maintaining the WLAN access state performs mobile IP registration, the FA 600 for WLAN performs mobile IP authentication for RADIUS (Remote Authentication Dial-In User Services) and registration for a home agent (HA) 700.

When the mobile IP registration is finished, the mobile terminal 100 transmits and receives data through the HA 700 and the FA 600. The mobile terminal 100 periodically measures WLAN signal strength during the data communication using the WLAN. When the measured signal strength is smaller than a reference value, the mobile terminal 100 attempts to change the access. That is, when signal strength of the AP having the access allowable SSID is greater than the reference value, the mobile terminal 100 changes the AP for the WLAN access. Here, when the previous AP is positioned in the same FA area as the new AP, an additional mobile IP registration procedure is not necessary.

If an adjacent AP does not exist, the mobile terminal 100 starts a mobile phone network access procedure. The data transmission/reception is continuously performed through the WLAN until the mobile IP of the mobile phone network starts to operate. When a mobile IP registration procedure starts in the mobile terminal 100 through the mobile phone network, the data transmission/reception using the WLAN is intercepted. When the mobile IP registration procedure is finished, the data transmission/reception is performed through the mobile phone network.

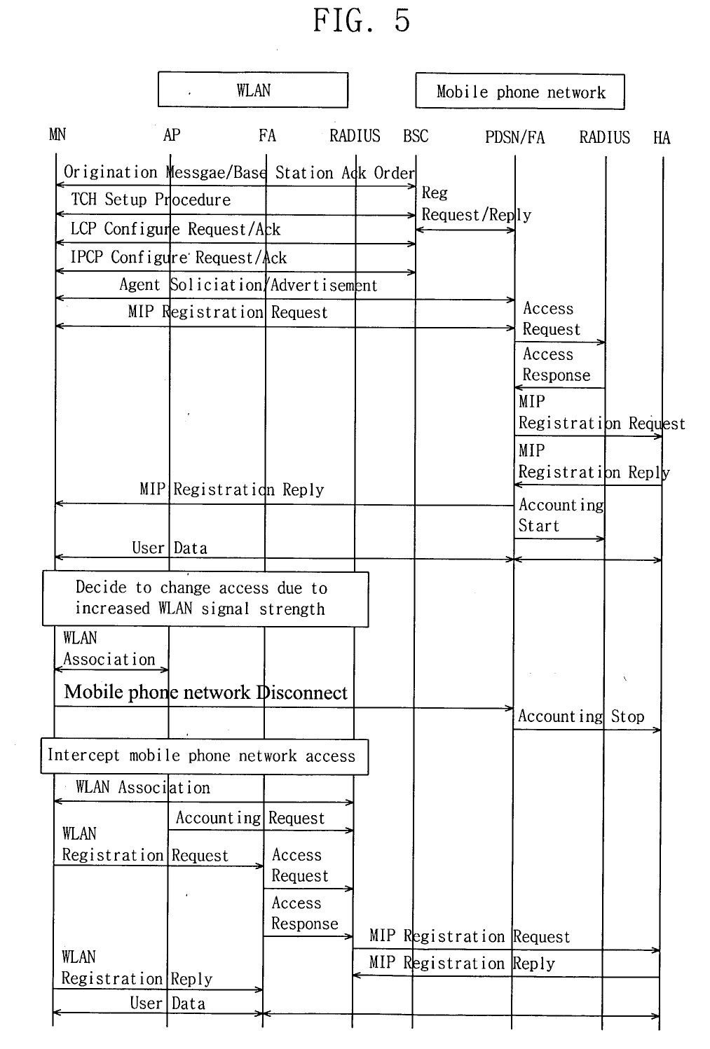

FIG. 5 is an exemplary view illustrating a procedure of interworking data services during a roaming operation from the mobile phone network to the WLAN in accordance with the present invention.

As shown in FIG. 5, the mobile terminal 100 transmits/receives data through the mobile phone network and periodically measures WLAN signal strength. When signal strength of the AP having the access allowable SSID is greater than a reference value, the mobile terminal 100 accesses the corresponding AP and intercepts the access to the mobile phone network.

Thereafter, when a mobile IP registration procedure using the WLAN is finished, the data transmission/reception is performed through the HA 700 and the FA 600 for WLAN.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

As discussed earlier, in accordance with the present invention, the method for selecting the system and transmitting data for the WLAN/mobile phone network interworking service selects the data transmission system and transmits data through the system to provide the interworking service in the environment where the WLAN which provides the high speed wireless internet access service based on hot spots and the mobile phone network which provides the national communication service coexist, thereby efficiently interworking services between the WLAN and the mobile phone network. As a result, the wireless internet service can be facilitated.

What is claimed is:

1. A method for selecting a system and transmitting data for a WLAN/mobile phone network interworking service in a WLAN/mobile phone network interworking system, comprising:
a signal measuring step for setting up a service set ID list of a WLAN in an access point in order for a terminal to allow access, and measuring signal strength for the WLAN access;
an access deciding step for selecting an access system based on the signal strength measured in the signal measuring step;
a WLAN performing step for periodically measuring signal strength of a WLAN channel satisfying the access allowable service set ID list, and accessing the corresponding WLAN channel or a mobile phone network according to the existence or absence of the WLAN channel guaranteeing signal quality for the WLAN access, when the WLAN access is confirmed in the access deciding step; and
a mobile phone network performing step for periodically measuring signal strength of the WLAN channel satisfying the access allowable service set ID list, and converting the mobile phone network access into the WLAN access according to sufficient signal strength for the access, when the mobile phone network access is confirmed in the access deciding step.

2. The method according to claim 1, wherein, in the signal measuring step, the service set IDs used as system identifiers are set up in the access point to be distinguished from other providers or individual users, and the terminal sets up one or plural access allowable service set IDs.

3. The method according to claim 1, wherein the WLAN performing step comprises:
a first step for periodically measuring signal strength of the current channel in the WLAN communication state;
a second step for measuring signal strength of other WLAN channels when the value measured in the first step is smaller than a reference value;
a third step for extracting channels having the access allowable service set ID among the channels having values over the reference value in the second step; and
a fourth step for accessing the access point of the channel having the largest signal strength among the channels extracted in the third step.

4. The method according to claim 3, wherein the third or fourth step comprises a step for accessing the mobile phone network, when the channel having signal strength over the reference value does not exist or when the channel having the access allowable service set ID does not exist after measuring signal strength of other WLAN channels.

5. The method according to claim 1, wherein the WLAN performing step comprises:
a first step for periodically measuring WLAN signal strength during the data transmission/reception using the mobile phone network;
a second step for accessing a corresponding access point and intercepting access to the mobile phone network, when signal strength of the access point having the access allowable service set ID is greater than a reference value; and
a third step for performing the data transmission/reception through a home agent and a foreign agent for WLAN, after mobile IP registration is performed through the WLAN.

6. The method according to claim 1, wherein the mobile phone network performing step comprises:
a first step for periodically measuring signal strength of a WLAN channel in the mobile phone network access state;
a second step for confirming whether a channel having the access allowable service set ID exists after the first step;
a third step for repeating the first step when the channel having the access allowable service set ID does not exist in the second step, and confirming whether the measured signal value is greater than a reference value when such channel exists; and
a fourth step for accessing a corresponding WLAN channel when the measured signal value is greater than the reference value in the third step, and periodically measuring signal strength of the WLAN channel having the access allowable service set ID and repeating the third step when the measured signal value is smaller than the reference value.

7. The method according to claim 1, wherein the mobile phone network performing step comprises:
a first step for performing mobile IP registration in the WLAN access state, and performing registration for a home agent;
a second step for performing data transmission/reception through the home agent and a foreign agent after the mobile IP registration;
a third step for periodically measuring WLAN signal strength during the data communication, and measuring adjacent WLAN signal strength to change access when the measured signal strength is greater than a reference value; and
a fourth step for changing the access point for the WLAN access, when signal strength of another access point having the access allowable service set ID is greater than the reference value.

8. The method according to claim 7, wherein the first step further comprises a step for performing mobile IP authentication for remote authentication dial-in user services.

9. The method according to claim 7, wherein the fourth step does not perform an additional mobile IP registration procedure, when a previous access point and a new access point are located in the same foreign agent area.

10. The method according to claim 7, wherein the third step comprises the steps of:
attempting to access the mobile phone network when an adjacent WLAN access point does not exist, and continuously performing the data transmission/reception through the WLAN until the mobile IP of the mobile phone network starts to operate; and
intercepting the data transmission/reception using the WLAN when the mobile IP registration procedure starts, and performing the data transmission/reception through the mobile phone network after finishing the mobile IP registration procedure.

11. The method according to claim 1, wherein the signal measuring step extracts the channels having the access allowable service set ID, measures signal strength of the channels, and decides the access system.

12. The method according to claim 1, wherein, when the terminal accesses the mobile phone network because WLAN signal strength becomes smaller than a reference value, the WLAN signal strength for starting to access the mobile phone network is set up to have a value for maintaining data communication through the WLAN for a call setup time of the mobile phone network.

13. The method according to claim 1, wherein the data transmission/reception is continuously performed through the WLAN until a mobile IP registration procedure starts in the mobile phone network, to prevent data interception during the roaming service.

14. The method according to claim 1, wherein, when the terminal accesses the WLAN because WLAN signal strength becomes greater than a reference value, the terminal cancels access to the mobile phone network directly after accessing the WLAN access point.

15. The method according to claim 1 or 11, wherein, when signal strength from the current WLAN access point becomes smaller, signal strength of the adjacent WLAN access point having the access allowable service set ID is measured.
